(19) United States
(12) Patent Application Publication
(10) Pub. No.: US 2014/0018089 A1
(43) Pub. Date: Jan. 16, 2014

(54) BANDWIDTH AND POWER ALLOCATIONS FOR COMMUNICATION NETWORKS WITH IMPERFECT SPECTRUM SENSING

(71) Applicant: THE HONG KONG UNIVERSITY OF SCIENCE AND TECHNOLOGY, Kowloon (HK)

(72) Inventors: Yuan WU, Hong Kong (CN); Danny Hin Kwok TSANG, Hong Kong (CN)

(73) Assignee: THE HONG KONG UNIVERSITY OF SCIENCE AND TECHNOLOGY, Kowloon (HK)

(21) Appl. No.: 13/970,411

(22) Filed: Aug. 19, 2013

Related U.S. Application Data
(62) Division of application No. 13/113,462, filed on May 23, 2011.
(60) Provisional application No. 61/429,916, filed on Jan. 5, 2011.

(51) Int. Cl. H04W 72/08

(52) U.S. Cl. CPC H04W 72/085
USPC 455/452.1

(57) ABSTRACT

Optimizing use, by a secondary terminal, of an idle wireless communication channel that is associated with a primary terminal is presented herein. A mapping component can receive: information including an indication that a communication channel assigned to a wireless device is idle; and one or more requests, from respective other wireless devices, to transmit information via the communication channel. Further, an allocation component can compute power allocations of the one or more requests, and grant a request of the one or more requests based on the power allocations. The allocation component can further be configured to iteratively compute a power allocation of the power allocations based on a bandwidth allocation of the bandwidth allocations; and iteratively compute a bandwidth allocation of the bandwidth allocations based on a power allocation of the power allocations.

### PRIORITY CLAIM

This patent application is a divisional of U.S. patent application Ser. No. 13/113,462, filed on May 23, 2011, entitled “BANDWIDTH AND POWER ALLOCATIONS FOR COMMUNICATION NETWORKS WITH IMPERFECT SPECTRUM SENSING”, which claims priority to U.S. Provisional Patent Application Ser. No. 61/429,916, filed on Jan. 5, 2011, entitled “JOINT BANDWIDTH AND POWER ALLOCATIONS FOR COGNITIVE RADIO NETWORKS WITH IMPERFECT SPECTRUM SENSING.” The entireties of the aforementioned applications are incorporated by reference herein.

### TECHNICAL FIELD

This disclosure relates generally to communication networks including, but not limited to, bandwidth and power allocation for cognitive radio networks with imperfect spectrum sensing.

### BACKGROUND

Cognitive radio (CR) technology involves a mechanism for adaptively modifying wireless communication, e.g., in response to wireless network and/or associated user demand. For example, CR systems can modify wireless communication parameter(s), e.g., based on measured, or sensed condition(s). In one example, a communication channel that is accessible by a device associated with a primary user (PU) can be utilized by a device associated with a secondary user (SU) if the communication channel is idle, or not utilized by the PU; however, CR technology does not effectively address quality of service (QoS) requirements associated with use of the communication channel by the SU. Further, CR technology does not effectively enable use of the communications channel by the PU under imperfect spectrum sensing conditions.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject disclosure. Its sole purpose is to present some concepts of the disclosed subject matter in a simplified form as a prelude to the more detailed description presented later.

Various systems, methods, and apparatus described herein opportunistically allocate use of an idle communication channel associated with a PU based on bandwidth characteristics of requested wireless transmission(s) associated with respective secondary users (SUs) of the idle communication channel, and power characteristics of the wireless transmission(s).

For example, a method can include evaluating a use of a communication channel by a wireless communication device; determining power allocations of transmissions, via the communication channel, requested by respective other wireless communication devices; and assigning, based on the power allocations, a use of the communication channel by at least one wireless communication device of the respective other wireless communication devices.

In an aspect, the method can include minimizing a total power allocation of coexisting transmissions of the transmissions. In another aspect, the method can include determining bandwidth allocations of the transmissions, and assigning the use of the communication channel based on the bandwidth allocations. In yet another aspect, the method can include iteratively updating a bandwidth allocation of the bandwidth allocations based on a power allocation of the power allocations; and iteratively updating a power allocation of the power allocations based on a bandwidth allocation of the bandwidth allocations.

In an aspect, the method can include receiving interference information associated with a communication between a base station and a wireless communication device of the respective other wireless communication devices, and assigning the use of the communication channel based on the interference information. In another aspect, the method can include receiving uplink information associated with uplink interference received by the base station; determining, based on the uplink information, an average level of uplink interference received by the base station; determining whether the average level of uplink interference exceeds a threshold amount of uplink interference; and assigning the use of the communication channel if the average level of uplink interference does not exceed the threshold amount of uplink interference. In yet another aspect, the method can includes determining whether the average level of uplink interference exceeds the threshold amount of uplink interference based on spectrum sensing accuracy associated with the SU, which can depend on a detection probability and a false alarm probability, and estimated statistics of communication traffic associated with the PU, e.g., occurring on the licensed wireless communication channel.

In another example, a system can include a mapping component configured to receive: information including an indication that a communication channel assigned to a wireless device is idle; and one or more requests, from respective other wireless devices, to transmit information via the communication channel. Further, the system can include an allocation component configured to: compute power allocations of the one or more requests; and grant a request of the one or more requests based on the power allocations. In an aspect, the allocation component can further be configured to minimize a sum of the power allocations to obtain a result, and grant the request based on the result. In another aspect, the allocation component can further be configured to compute bandwidth allocations of the one or more requests, and grant the request based on the bandwidth allocations.

In yet another aspect, allocation component can further be configured to iteratively compute a power allocation of the power allocations based on a bandwidth allocation of the bandwidth allocations. Further, the allocation component can further be configured to iteratively compute a bandwidth allocation of the bandwidth allocations based on a power allocation of the power allocations. In one aspect, the mapping component can further be configured to receive power gain information associated with a communication between a base station and a wireless device of the other wireless devices; and allocation component can further be configured to grant the request based on the power gain information. In another aspect, the mapping component can further be configured to receive uplink information associated with uplink interference associated with the base station; and allocation component can further be configured to compute, based on the uplink information, an average uplink interference associated with the base station, and grant the request based on the average uplink interference.

In yet another example, an apparatus can include means for determining a use of a communication channel by a wireless device; means for determining power allocations and bandwidth allocations of transmissions on the communication channel requested by respective other wireless devices; and means for assigning, based on the power allocations and the bandwidth allocations, respective uses of the communication channel by the respective other wireless devices.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates a block diagram of a cognitive radio (CR) system, in accordance with an embodiment

FIG. 2 illustrates a block diagram of a CR base station, in accordance with an embodiment.

FIGS. 3-8 illustrate performance characteristics of a CR system, in accordance with an embodiment.

FIGS. 9-10 illustrate various processes associated with a CR system, in accordance with an embodiment.

FIG. 11 illustrates a block diagram of a computing system operable to execute the disclosed systems and methods, in accordance with an embodiment.

### DETAILED DESCRIPTION

Various non-limiting embodiments of systems, methods, and apparatus presented herein optimize a use of an idle wireless communication channel, which is associated with a primary user (PU), by secondary user(s) (SUs) based on bandwidth requirement(s) and power allocations associated with the use.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to, automatically, iteratively compute a power allocation of the power allocations based on a bandwidth allocation of the bandwidth allocations. Further, the artificial intelligence component can be used to automatically, iteratively compute a bandwidth allocation of the bandwidth allocations based on a power allocation of the power allocations.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media.

Typically, two types of user equipment can be utilized within a cognitive radio (CR) system: (1) primary user equipment, including primary user terminals (PUTs), primary user terminal (PUT) wireless communication devices, etc. and (2) secondary user equipment, including secondary user nodes, secondary user terminals (SUTs), secondary user terminal (SUT) wireless communication devices, etc. Primary user equipment generally includes a wireless interface device, e.g., wireless transmitter, wireless receiver, wireless transceiver, etc. that is licensed for use on a particular frequency spectrum, or that employs a service allocated to the particular frequency spectrum. Secondary user equipment, on the other hand, is generally not licensed for use on the particular frequency spectrum, or utilizes a different service than what the frequency spectrum is allocated for, e.g., a cellular phone can be a SUT on a frequency spectrum allocated for broadcast television, and/or the cellular phone can be a SUT on a frequency spectrum allocated for 802.11 wireless communications, etc.

As described above, use of a licensed frequency spectrum, or a licensed communication channel, can be allocated to a SUT if the licensed communication channel is idle, or not used, by the primary user; however, conventional CR technology does not effectively address quality of service (QoS) requirements associated with use of the licensed communication channel via secondary user equipment. Further, conventional cognitive radio technology does not effectively protect use of the licensed communications channel via primary user equipment under imperfect spectrum sensing conditions, e.g., when the licensed communication channel is mistakenly identified as being idle, e.g., during a misdetection. Compared to such technology, various systems, methods, and apparatus described herein in various embodiments can improve a use of the licensed communication channel by secondary user equipment by determining optimal bandwidth and power allocations associated with the secondary user equipment. Further, such embodiments can improve use of the licensed communication channel via primary user equipment by reducing misdetection(s).

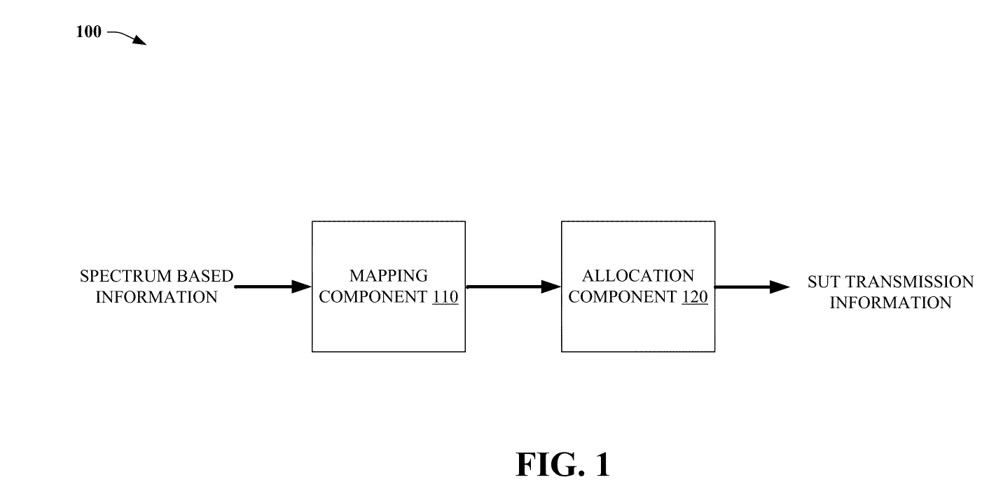

Referring now to FIG. 1, a block diagram of a CR system 100 is illustrated, in accordance with an embodiment. Aspects of CR system 100, and systems, networks, other apparatus, and processes explained herein can include, and operate under, various electromagnetic radiation based communication technologies including cellular, wireless local area network (WLAN), amateur radio, non-cognitive, etc. Further, such aspects can include constitute machine-executable instructions embodied within machine(s), e.g., embodied in one or more computer readable mediums (or media) associated with one or more machines. Such instructions, when executed by the one or more machines, e.g., computer(s), computing device(s), virtual machine(s), etc. can cause the machine(s) to perform the operations described.

Additionally, the systems, apparatus, and processes explained herein can be embodied within hardware, such as an application specific integrated circuit (ASIC) or the like. Further, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

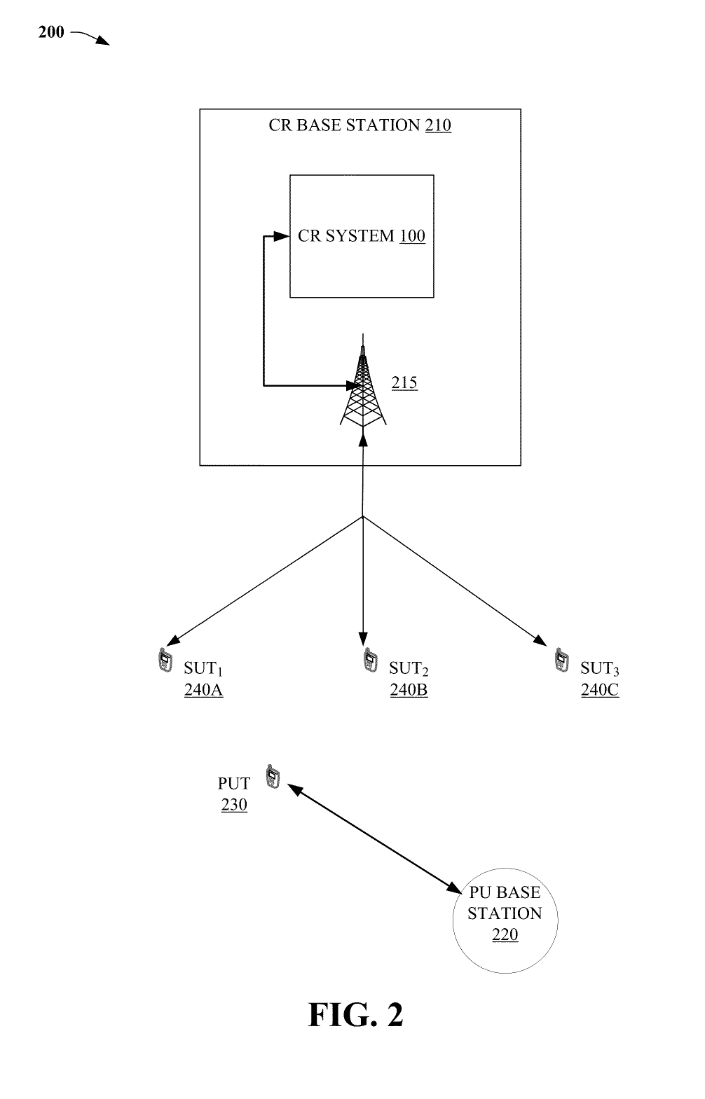

As illustrated by FIG. 1, CR system 100 can include mapping component 110 and allocation component 120. In an aspect, CR system 100 can be a CR base station (see e.g. FIG. 2 infra) that can be configured to communicate with primary user equipment, e.g., via licensed (or pre-allocated) electromagnetic spectra, wireless communication channel(s), etc. Further, the CR base station can be configured to communicate with secondary user equipment, via the licensed wireless communication channel, e.g., when the licensed wireless communication channel is not used by the primary user equipment.

In one aspect, mapping component 110 can be configured to receive spectrum based information, which can include: (1) information suggesting, indicating, etc. that one or more licensed wireless communication channels associated with respective PUTs (not shown) are idle; (2) bandwidth, or QoS, information (or requirement) associated with one or more requested uses, etc. of the one or more licensed wireless communication channels by respective SUTs (not shown); and/or (2) power gain information of communications between base stations associated with the respective PUTs and the respective SUTs, e.g., associated with, for example, estimated uplink interference received by the base stations. In another aspect, mapping component 110 can be configured to receive the spectrum based information via uplink messages communicated by the respective SUTs.

In yet another aspect, secondary user terminals can be configured to (1) determine, e.g., as idle information, whether wireless communication channels associated with respective primary users are idle; (2) estimate, e.g., as interference information, the uplink interference; and (3) communicate, e.g., as the spectrum based information, the idle information and the interference information to mapping component 110. For example, mapping component 110 can be configured to receive one or more portions of the spectrum based information from SUTs via respective uplink messages transmitted by the SUTs. In another example, mapping component 110 can be configured to coordinate, request, etc. the SUTs to perform distributed spectrum sensing to derive the one or more portions of the spectrum information.

In yet another aspect, mapping component 110 can be configured to receive the spectrum based information from one or more sensing components included in CR system 100 (not shown). The one or more sensing components can be configured to measure, determine, evaluate, receive, etc. (1) information indicating whether the wireless communication channels associated with the respective primary users are detected to be idle, e.g., the idle information; (2) bandwidth information, e.g., minimum bandwidth requirements, associated with the one or more requested uses; and/or (3) power gain information, or the interference information, of communications between the base stations and the respective SUTs, e.g., associated with uplink interference estimated to be received by the base stations. In one aspect, mapping component 110 can be configured to derive, based on the spectrum based information, an idle spectrum map, which maps, correlates, etc. the idle information to the bandwidth information and the interference information.

In one aspect, allocation component 120 can be configured to allocate, based on the spectrum based information and/or the idle spectrum map, use of a licensed wireless communication channel by one or more secondary user terminals, or coexisting SUTs, by minimizing a total power allocation of transmissions of the coexisting SUTs via the licensed wireless communication channel. For example, allocation component 120 can be configured to generate SUT transmission information defining the allocated use, and communicate the SUT transmission information to the coexisting SUTs via one or more downlink messages.

In another aspect, allocation component 120 can be configured to allocate, for a licensed wireless communication channel associated with a PUT, a power of a transmission of a SUT of the coexisting SUTs based on (1) iteratively updating the power by fixing a bandwidth allocation of the SUT, and (2) iteratively updating the bandwidth allocation by fixing the power, until a predetermined precision of an associated result, or a predetermined level of iterations, is obtained.

In yet another aspect, the allocation component 120 can be configured to allocate the use of the licensed wireless communication channel by the SUT based on an interference constraint associated with communication(s), e.g., uplink transmissions(s), between the PUT and a base station associated with the primary user. For example, the interference constraint can include a threshold amount of interference estimated to occur on the licensed wireless communication channel via the uplink transmission(s) between the PUT and the base station associated with the PU, relative to an average level of interference estimated to occur on the licensed wireless communication channel.

In one aspect, the interference constraint can be based on the detection probability and the false alarm probability, and the estimated statistics of the communication traffic associated with the PU that is occurring on the licensed wireless communication channel. For example, if the amount of traffic estimated to be occurring on the licensed wireless communication channel is higher than an average amount of traffic estimated to be occurring on the licensed wireless communication channel, then the interference constraint can be more conservative, restrictive, etc. As such, in an aspect, allocation component 120 can be more restrictive in allocating the use of the wireless communication channel by the SUT.

In another aspect, a mis-detection probability can be based on a probability that the idle information is incorrect, e.g., resulting in a misdetection and interference to the PUT. For example, as the probability that the idle information is incorrect increases, the interference constraint can be more conservative. As such, in an aspect, the allocation component 120 can be more restrictive in allocating the use of the wireless communication channel by the SUT.

FIG. 2 illustrates a block diagram of a system 200 including a CR base station 210 and a primary user base station (PU BS) 230, in accordance with an embodiment. As described above, CR base station 210 can include one or more components of CR system 100. In an aspect illustrated by FIG. 2, CR base station 210 can include wireless access point 215, which can be coupled to one or more components of system 100 to transfer to/from the one or more components information associated with wireless communications transmitted to and/or received from: (1) primary user equipment, e.g., PUT 230, via a licensed (or pre-allocated) electromagnetic spectra, wireless communication channel, etc. and (2) secondary user equipment, e.g., SUT₁ 240A, SUT₂ 240B, and SUT₃ 240C, via the licensed wireless communication channel, e.g., when the licensed wireless communication channel is not used by PUT 230. The wireless communications transmitted to/ and or received from the primary user equipment and/or the secondary user equipment can include cellular based communications, wireless local area network (WLAN) based communications, e.g., Institute of Electrical and Electronics Engineers (IEEE) 802.11 (a, b, g, n, etc.) based communications, amateur radio based communications, non-cognitive based communications, etc.

The following discussion refers to aspects of system 200, and can also refer to aspects of CR system 100 and various components of such systems, and related methods and apparatus, etc. which can utilize such aspects to improve use, by secondary user terminal(s), of licensed communication channels associated with respective primary user terminals.

In one aspect, system 200, etc. can operate on a set of licensed channels [symbol] ={0, 1, . . . , K}. In one aspect, [symbol] ={1, . . . , K} can denote the set of licensed channels that have already been allocated to a set of PU networks [symbol] ={1, 2, . . . , M}, e.g., via one or more authorities. The PU networks can reuse their licensed channels if certain conditions are satisfied. Further, to improve spectrum efficiency, system 200, etc. can enable opportunistic access to channels in [symbol] , or a set of opportunistic channels, when such channels are not being used by respective primary users. System 200, etc. can utilize an on-off model to represent the channel availability state for each opportunistic channel, in which s^{k}=1 denotes channel k is idle, while s^{k}=0 denotes channel k is busy. Further, vector s=(s¹, . . . , s^{K}) can denote the channel availability states for the opportunistic channels. Furthermore, channel k=0 can denote a reserved channel to which system 200, etc. can resort for data transmission.

In another aspect, system 200, etc. can coordinate SUs to perform distributed spectrum sensing, and generate a consensus idle spectrum map for determining bandwidth allocation associated with the SUs. In yet another aspect, spectrum sensing accuracy of system 200, etc. can be characterized by the false alarm probability (or P_{fa}) which in one aspect can refer to a probability that a sensing result indicates a channel state is busy, while the actual channel state is idle; and the detection probability (or P_{ds}), which in one aspect can refer to a probability that a sensing result indicates a channel state is busy, while the actual channel state is busy.

Let \tilde{s}=(\tilde{s}¹, . . . , \tilde{s}^{K}) denote the spectrum sensing results. Due to the imperfect spectrum sensing, \tilde{s} may not be equal to s, thus causing waste of channel opportunities when false alarm(s) occur and/or interference to respective PUs when misdetection occurs. As such, in an aspect, system 200, etc. can utilize the interference constraint (see above) associated with the respective PUs. The interference constraint can be based spectrum sensing accuracy of system 200, etc. and information of statistical activities of the PUs, e.g., values of channel idle, or busy state, probability Pr{s^{k}=1}(Pr{s^{k}=0}), ∀kε [symbol] .

System 200, etc. can consider a set of SUs [symbol] ={1, 2, . . . , N} associated with a CR base station, e.g., 210. Each SU i can have its own QoS requirement, in terms of a data rate Rᵢ^{req}. Further, system 200, etc. can divide each idle channel into multiple subchannels with continuous bandwidths, and allocate such subchannels to different SUs. For example, system 200, etc. can divide each idle channel into the multiple subchannels using orgothognal frequency-division multiplexing (OFDM), or multiband OFDM (MB-OFDM) via the physical layer (PHY) to simultaneously transmit on a set of discrete frequency channels.

In an aspect, system 200, etc. can perform uplink bandwidth and power allocations for SUs utilizing a licensed channel of a primary user according to P1 (equations (1)-(5)) as follows:

$$( P 1 ) \text{:} {min}_{\text{?} {b}_{i} , {p}_{i} {\text{?}}_{i ∈ N}} {\sum }_{i ∈ N}^{ } {w}_{i} {\sum }_{k ∈ x}^{ } {p}_{i}^{k} , \\ \text{?} \text{indicates text missing or illegible when filed} \qquad ( 1 )$$

subject to:

[symbol]

bᵢ^{k}≦\tilde{s}^{k}B^{k}, ∀kε [symbol] ; [symbol] bᵢ^{B}≦B^{a} (2)

Eₛk[Iₘ^{k}(p^{k},s^{k})[\tilde{s}^{k}]≦Γₘ^{k}, ∀kε [symbol] , mε [symbol] , \tilde{s}^{k}ε{0,1} (3)

[symbol]

Φ(bᵢ^{k},pᵢ^{k})≧Rᵢ^{req}, ∀iε [symbol] (4)

B^{k}≧bᵢ^{k}≧ε, pᵢ^{k}≧0, ∀iε [symbol] , kε [symbol] (5)

Based on sensing result \tilde{s}, system 200, etc. can utilize P1 to minimize the weighted total power allocation (assuming each SU has a sufficient power capacity) by determining (i) each SU i's bandwidth allocation vector bᵢ=(bᵢ⁰, . . . , bᵢ^{K}) and (ii) each SU i's power allocation vector pᵢ=(pᵢ⁰, . . . , pᵢ^{K}). The weight parameter wᵢ denotes SU i's sensitivity to power consumption.

Equation (2) models the opportunistic spectrum access to channels of the PUs. If channel kε [symbol] is sensed to be idle (e.g., \tilde{s}^{k}=1), then the total bandwidth utilization [symbol] bᵢ^{k} cannot exceed bandwidth B^{k} of channel k. System 200, etc. can utilize a reserved channel k=0 with bandwidth B⁰ for traffic delivery even if all the opportunistic channels are sensed to be busy.

As stated above, system 200, etc. can utilize the interference constraint to protect PUs under imperfect spectrum sensing. For example, system 200, etc. can model the interference constraint for PUs utilizing equation (3). Specifically, the interference constraint, or function, can be expressed as Iₘ^{k}(p^{k}, s^{k})= [symbol] pᵢ^{k}hᵢₘ^{k} when s^{k}=0, and lₘ^{k}(p^{k}, s^{k})=0 when s^{k}=1, in which vector p^{k}=(p₁^{k}, . . . , p_{N}^{k}) denotes power allocations of SUs on channel k, and hᵢₘ^{k} denotes the channel power gain from SU i to a base station (PU's BS) m (e.g., PU base station 220) of a respective PU of the PUs. In an aspect, system 200, etc. can obtain hᵢₘ^{k} utilizing channel estimation techniques, e.g., based on signal strength measurements made by respective SUs and/or respective PUs. In one aspect, system 200, etc. can utilize equation (3), based on a current sensing result \tilde{s}^{k}, to determine whether an average interference level (or constraint), associated with uplink interference received by the PU's BS m on channel k, cannot exceed a threshold Γₘ^{k}.

In one example, system 200, etc. can evaluate the average interference constraint according to equation (3), by defining a posterior probability function A(\tilde{s}^{k}) according to equation (6) as follows:

A(\tilde{s}^{k})=Pr{s^{k}=0|\tilde{s}^{k}}, \tilde{s}^{k}ε{0,1} (6)

Further based on the definition of the interference function Iₘ^{k}(p^{k}, s^{k}), constraint (3) can then be expressed as A(\tilde{s}^{k})Σ_{iεM} pᵢ^{k}hᵢₘ^{k}≦Γₘ^{k}, ∀kε [symbol] , mε [symbol] , \tilde{s}^{k}ε{0,1}. In another example, system 200, etc. can perform power allocation based on spectrum sensing accuracy and statistical activities of PUs.

For example, if \tilde{s}^{k}=1, kε [symbol] , then constraint (3) on channel k can be expressed as A(1) [symbol] pᵢ^{k}hᵢₘ^{k}≦Γₘ^{k}, Vmε [symbol] , in which

$$\begin{matrix}A ( 1 ) = Pr \{ {s}^{k} = 0 \vert {\tilde{s}}^{k} = 1 \} \\ = \frac{( 1 - {P}_{de )} Pr ( {s}^{k} = 0 )}{( 1 - {P}_{de )} Pr ( {s}^{k} = 0 ) + ( 1 + {P}_{fa} ) Pr \{ {s}^{k} = 1 \}} .\end{matrix}$$

Further, the detection probability P_{ds}=Pr{\tilde{s}^{k}=0|s^{k}=0}, and the false alarm probability P_{fa}=Pr{\tilde{s}^{k}=0|s^{k}=1}, ∀kε [symbol] , can be determined by system 200, etc. Thus, the larger the P_{ds}, the more aggressive system 200, etc. can be in using the opportunistic channel k when the opportunistic channel k is sensed to be idle. However, the smaller the Pr{s^{k}=1} (e.g., the larger the Pr{s^{k}=0}, which can indicate that PUs have a heavier traffic load on channel k), the more conservative system 200, etc. can be in using the opportunistic channel k, even if the opportunistic channel k is sensed to be idle.

According to equation (4), in an aspect, each SU i can obtain its required transmission rate Rᵢ^{req}. Specifically, a capacity function on each subchannel can be expressed as equation (7) as follows:

$$Φ ( {b}_{i}^{k} , {p}_{i}^{k} ) = {b}_{i}^{k} {log}_{2} ( 1 + \frac{{p}_{i}^{k} {h}_{i}^{k}}{{b}_{i}^{k} {N}_{0}} ) . \qquad ( 7 )$$

in which hᵢ^{k} denotes the channel power gain from SU i to a CR base station, e.g., 210. N₀ denotes the power spectral density of background noise. Specifically, the interference from all PUs can be considered as a random variable depending on whether misdetection occurs, and whether PU BS m is using channel k. In one aspect, for simplification, interference from PUs is not considered into the capacity function (or equation (7)). As such, equation (7) represents an upper bound of the transmission rate a SUT can obtain.

In one aspect, all SU bandwidth allocations are coupled via equation (2). Further, SU power allocations are coupled via equation (3). Furthermore, each SU's bandwidth allocation and power allocation are coupled via equation (4). System 200, etc. can evaluate P1, or equations (1)-(5), using Lagrangian multipliers. For example, zᵢ can be used to denote a dual variable for SU i's QoS constraint, e.g., associated with equation (4), and u^{k} can be used to denote a dual variable for the bandwidth constraints on channel k, e.g., associated with equation (2). Further, vₘ^{k} can be used to denote a dual variable for PUs BS m's interference constraint on channel k, e.g., associated with equation (3). Further, given dual vectors (z, u, v), let (b*(z, u, v), p*(z, u, v)) denote equation (8) as follows:

$$( {b}^{\text{?}} ( z , u , v ) , {p}^{\text{?}} ( z , u , v ) ) = arg {min}_{b ∈ Bp \geq 0} F ( b , p , z , u , v ) , \\ \text{?} \text{indicates text missing or illegible when filed} \qquad ( 8 )$$

in which, the bandwidth feasible set [symbol] ={[bᵢ^{k}] [symbol] |B^{k}≧bᵢ^{k}≧ε, ∀lε [symbol] , kε [symbol] } and F(b, p, z, u, v)= [symbol] wᵢ [symbol] pᵢ^{k}− [symbol] zᵢ [symbol] Φ(bᵢ^{k}, pᵢ^{k})+ [symbol] u^{k} [symbol] bᵢ^{k}+u^{o} [symbol] bᵢ^{o}+ [symbol] [symbol] vₘ^{k}A(\tilde{s}^{k}) [symbol] pᵢ^{k}hᵢₘ^{k}. Furthermore, equation (1) can thus be equivalently solved by solving equation (9) as follows:

$${max}_{z , u , v \geq 0} D ( z , u , v ) = {max}_{z , u , v \geq 0} L ( {b}^{\text{?}} ( z , u , v ) , {p}^{\text{?}} ( z , u , v ) , z , u , v ) . \\ \text{?} \text{indicates text missing or illegible when filed} \qquad ( 9 )$$

In another aspect, system 200, etc. can evaluate equation (8) as follows. For any given dual vectors (z, u, v), first update power allocations of SUs by fixing their bandwidth allocations, then update bandwidth allocations of the SUs by fixing their power allocations. Further, system 200, etc. can repeat such steps until equation (8) is evaluated with an adequate precision. For example, system 200, etc. can utilize a best-response method, based on equation (8), to update the power allocations (by setting

$$\frac{\partial F}{\partial {p}_{i}^{k}} = 0 )$$

according to equation (10) as follows:

$${p}_{i}^{k} = \{ \begin{matrix}{{b}_{i}^{k} [ \frac{{z}_{i}}{( ln 2 )} \frac{1}{{w}_{i} + A ( {s}^{k} ) {\sum }_{m ∈ M}^{ } {s}_{m}^{k} {h}_{im}^{k}} - \frac{{N}_{0}}{{h}_{i}^{k}} ]}_{0}^{∞} , & ∀ \text{?} ∈ N , k ∈ \text{?} , & {z}_{i} \neq 0 \\ {{b}_{i}^{k} [ \frac{\text{?}}{( ln 2 )} \frac{1}{{w}_{i}} - \frac{{N}_{0}}{{h}_{i}^{k}} ]}_{0}^{∞} , & ∀ \text{?} ∈ N , k ∈ \text{?} , & {z}_{i} \neq 0 \\ 0 , ∀ \text{?} ∈ N , k ∈ \text{?} , & {z}_{i} \neq 0 & \end{matrix} \\ \text{?} \text{indicates text missing or illegible when filed} \qquad ( 10 )$$

Further, system 200, etc. can update bandwidth allocations of the SUs by utilizing a steepest gradient projection method according to equation (11) as follows:

$${b}_{i}^{k} = \{ \begin{matrix}[ \text{?} & ∀ \text{?} ∈ N , k ∈ K , & \text{?} \\ ɛ , ∀ \text{?} ∈ N , k ∈ K , & {z}_{i} = 0 , & {p}_{i}^{k} = 0\end{matrix} \\ \text{?} \text{indicates text missing or illegible when filed} \qquad ( 11 )$$

in which φ₁ is the stepsize and

$$\frac{\partial F}{\partial {b}_{i}^{k}} = \frac{{z}_{i}}{( ln 2 )} \frac{{p}_{i}^{k} {h}_{i}^{k}}{{b}_{i}^{k} {N}_{0} + {p}_{i}^{k} {h}_{i}^{k}} - {z}_{i} {log}_{2} ( 1 + \frac{{p}_{i}^{k} {h}_{i}^{k}}{{b}_{i}^{k} {N}_{0}} ) + {u}^{k} .$$

Furthermore, system 200, etc. can evaluate

$$\frac{{\partial }^{2} F}{\partial {b}_{i}^{\text{?}}} = \frac{{z}_{i}}{( ln 2 )} \frac{{( {p}_{i}^{k} {h}_{i}^{k} )}^{2}}{{( {p}_{i}^{k} {h}_{i}^{k} + {b}_{i}^{k} {N}_{0} )}^{2} + {b}_{i}^{k}} . \\ \text{?} \text{indicates text missing or illegible when filed}$$

Determining that

$$\frac{\partial F}{\partial {b}_{i}^{k}}$$

is increasing with bᵢ^{k} if zᵢ>0 and pᵢ^{k}>0, system 200, etc. can derive condition C1 as

$${z}_{i} > 0 , \\ {p}_{i}^{k} > 0 , \\ \frac{\partial F}{\partial {b}_{i}^{k}} {\vert}_{{b}_{i}^{k} = z} = \frac{{z}_{i}}{( In2 )} \frac{{p}_{i}^{k} {h}_{i}^{k}}{{sN}_{0} + {p}_{i}^{k} {h}_{i}^{k}} - {z}_{i} {log}_{2} ( 1 + \frac{{p}_{i}^{k} {h}_{i}^{k}}{{sN}_{0}} ) + {u}^{k} > 0 ;$$

and condition C2 as

$${z}_{i} > 0 , \\ {p}_{i}^{k} > 0 , \\ \frac{\partial F}{\partial {\text{?}}_{i}^{k}} {\vert}_{{\text{?}}_{i}^{k} = \text{?}} = \frac{{z}_{i}}{( ln 2 )} \frac{{p}_{i}^{k} {h}_{i}^{k}}{{B}^{k} {N}_{0} + {p}_{i}^{k} {h}_{i}^{k}} - {z}_{i} {log}_{2} ( 1 + \frac{{p}_{i}^{k} {h}_{i}^{k}}{{S}^{k} {N}_{0}} ) + {u}^{k} < 0.$$

$$\text{?} \text{indicates text missing or illegible when filed}$$

If condition C1 holds, then system 200, etc. can set hᵢ^{k}=ε. Further, if condition C2 holds, then system 200, etc. can set bᵢ^{k}=B^{k}.

Furthermore, system 200, etc. can update bandwidth allocations based on equation (12) as follows:

$${b}_{i}^{k} = \{ \begin{matrix}ɛ , & ∀ i ∈ N , k ∈ K , & {whenz}_{i} = 0 {orp}_{i}^{k} = 0 or ( C1 ) \\ {B}^{k} , & ∀ i ∈ N , k ∈ K , & when ( C2 ) \\ {[ {b}_{i}^{k} - {ϕ}_{1} \frac{\partial F}{\partial {b}_{i}^{k}} ]}_{E}^{{B}^{k}} , & ∀ i ∈ N , k ∈ K , & otherwise .\end{matrix} \begin{matrix} \\ \end{matrix} \qquad ( 12 )$$

In one aspect, system 200, etc. can select a stepsize φ₁ that satisfies 0<φ₁<2/G, in which

$$G = {max}_{i ∈ N} \frac{{z}_{i}}{( ln 2 ) s} .$$

In anomer aspect, system 200, etc. can set ε=0.01, and set a convergence precision (condition) for equation (12) as the relative difference between two consecutive updates of bandwidth allocation to be below than 10⁻².

In one example, system 200, etc. can, in a step (i), derive, according to a “best response method,” a solution to equation (8) by performing power allocation according to equation (10); and derive, according to a “steepest gradient projection method,” bandwidth allocation according to equation (12) for a number of iterations until the convergence precision condition is met, or a maximum iteration number S is reached. Further, system 200, etc. can, in a step (ii), update dual vectors, given (b*(z, u, v), p*(z, u, v)) for equation (8), according to equations (13)-(16) as follows:

For the dual vector z:

zᵢ=[zᵢ+φ₂(Rᵢ^{req}− [symbol] Φ(bᵢ^{k}*,pᵢ^{k}*))]₀^{∞}, ∀iε [symbol] . (13)

For the dual vector u:

u^{k}=[u^{k}+φ₃( [symbol] bᵢ^{k}*−\tilde{s}^{k}B^{k})]₀^{∞}, ∀kε [symbol] . (14)

u⁰=[u⁰+φ₄( [symbol] bᵢ⁰*−B⁰)]₀^{∞}. (15)

For the dual vector v:

vₘ^{k}=[vₘ^{k}+φ₅(A(\tilde{s}^{k}) [symbol] pᵢ^{k}*hᵢₘ^{k}−Γₘ^{k})]₀^{∞}, ∀mε [symbol] , kε [symbol] . (16)

Further, upon completion of step (ii), system 200, etc. can repeat step (i) until the convergence precision condition is met, or a given maximum iteration number is reached.

In an aspect, after deriving SU bandwidth and power allocation demands, e.g. (b*(z, u, v), p*(z, u, v)), system 200, etc. can perform the dual vector updatings according to equations (14)-(16). Further, each SU can perform the dual variable updating according to equation (13).

In other aspect, system 200, etc. can decompose equation (8) into N subproblems (one for each SU), and each SU can be configured to individually solve a respective subproblem of the subproblems based on equation (10) and equation (12). For example, a sub-gradient respect to dual vectors z, u and v can be given by: J(zᵢ)=Rᵢ^{req}− [symbol] Φ(bᵢ^{k}*, pᵢ^{k}*), ∀iε [symbol] ; J(u^{k})= [symbol] bᵢ^{k}*−\tilde{s}^{k}B^{k}, ∀kε [symbol] ; J(u⁰)= [symbol] bᵢ⁰*−B⁰; and J(vᵢ^{k})=A(\tilde{s}^{k}) [symbol] pᵢ^{k}*hᵢₘ^{k}−Γₘ^{k}, ∀iε [symbol] , kε [symbol] , in which (b*(z, u, v), p*(z, u, v)) is given by equation (8).

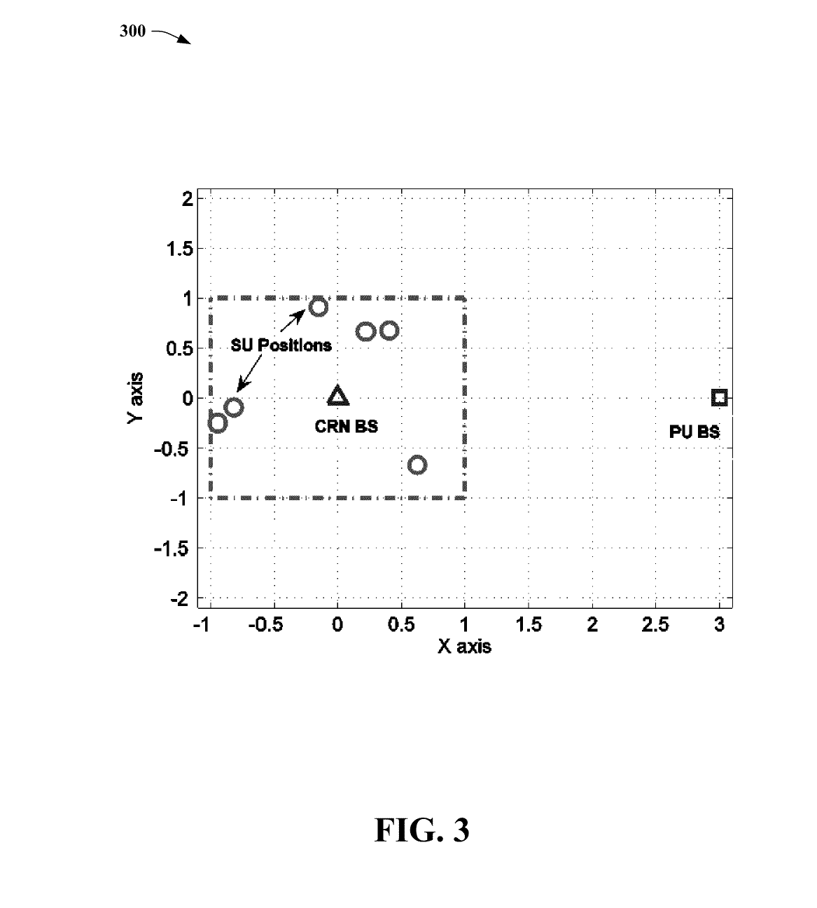

FIGS. 3-8 illustrate performance of system 200, etc. in utilizing one or more of equations (1)-(16) to optimize a use of idle wireless communication channels that are associated with respective PUs, by respective SUs, based on bandwidth requirement(s) and power allocations associated with the use, in accordance with an embodiment. In an aspect, S=100 and the convergence condition for the inner-layer iteration process, as the relative difference between two consecutive updates of (b, p), is set lower than 10⁻². As illustrated by FIG. 3, a CR network can include 6 SUs that are randomly distributed in the square area centered at (0,0) with side-length 2. Opportunistic channels [symbol] ={1, 2, 3} are used with (B¹, B², B³)=(7, 5, 3) units of normalized bandwidth, respectively. A reserved channel 0 with B⁰=3 units is also used. N₀=0.001. Further, Pr{s^{k}=1}=0.7, k=1, 2, 3 and P_{ds}=0.9, and P_{fa}=0.1. The interference tolerance threshold Γ₁^{k}=0.001, k=1, 2, 3. Further, the current spectrum sensing results are \tilde{s}¹=1, \tilde{s}²=1, \tilde{s}³=0, and (R₁^{req}, R₂^{req}, R₃^{req}, R₄^{req}, R₅^{req}, R₆^{req})=(10, 12, 14, 16, 18, 20).

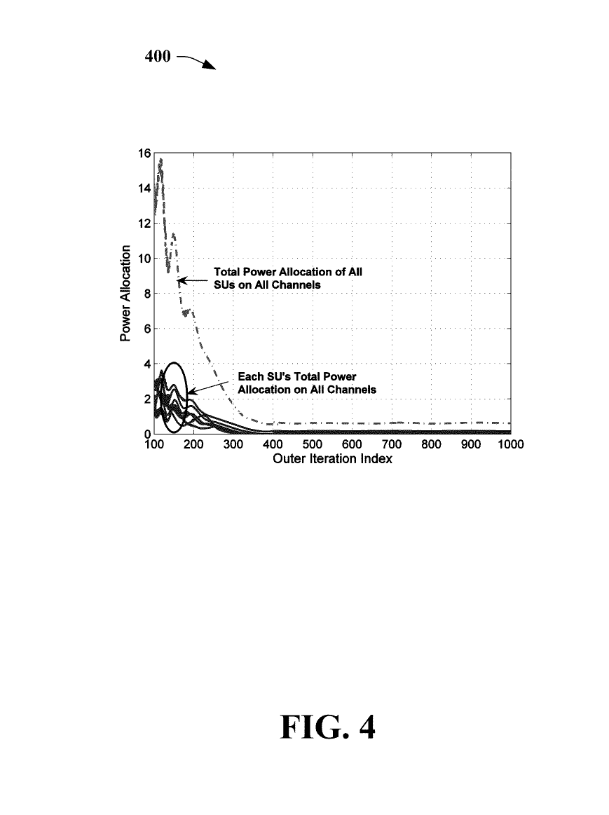

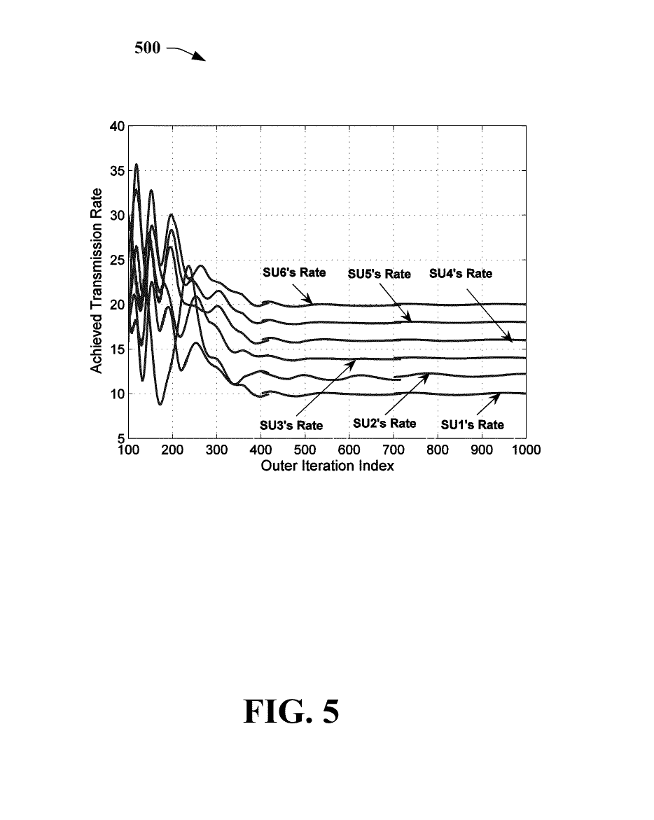

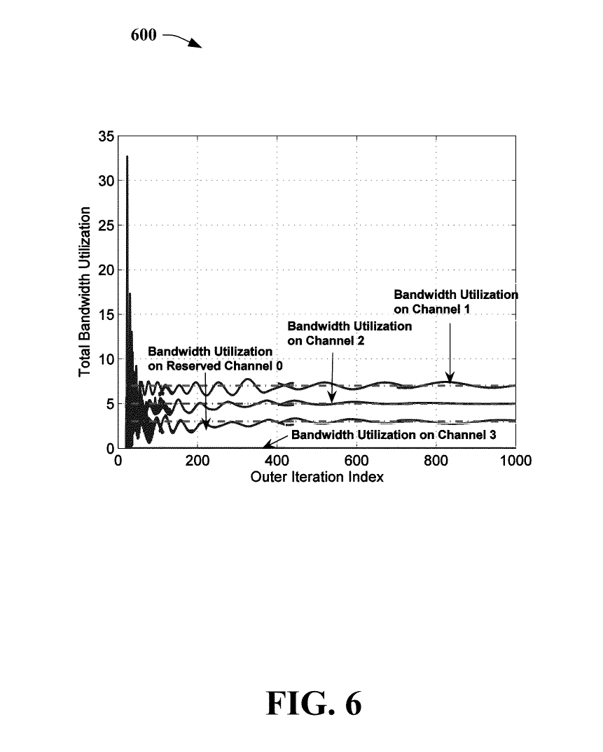

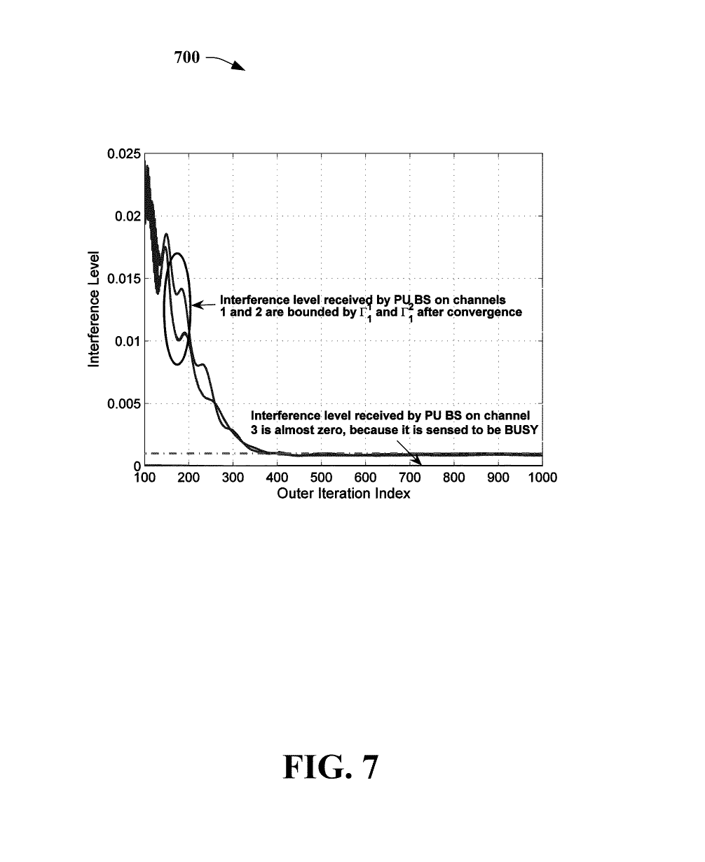

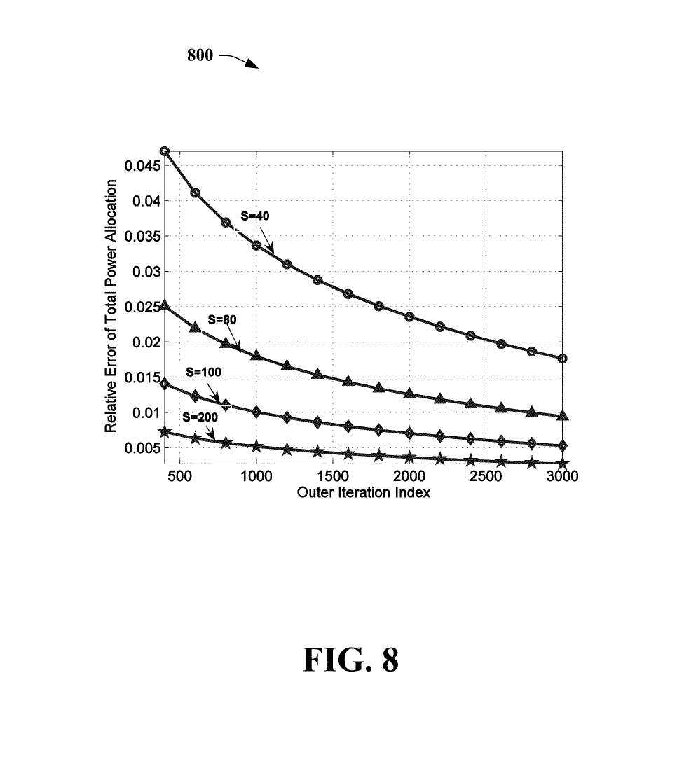

FIG. 4 illustrates convergence of power allocations of the respective SUs; FIG. 5 illustrates satisfaction of each SU's rate requirement after convergence; and FIGS. 6-7 illustrate the satisfaction, after convergence, of the channel bandwidth constraints, associated with equation (2), and the interference constraint associated with equation (3), respectively. FIG. 8 illustrates relative errors of total power allocation with S=40, 80, 100, and 200.

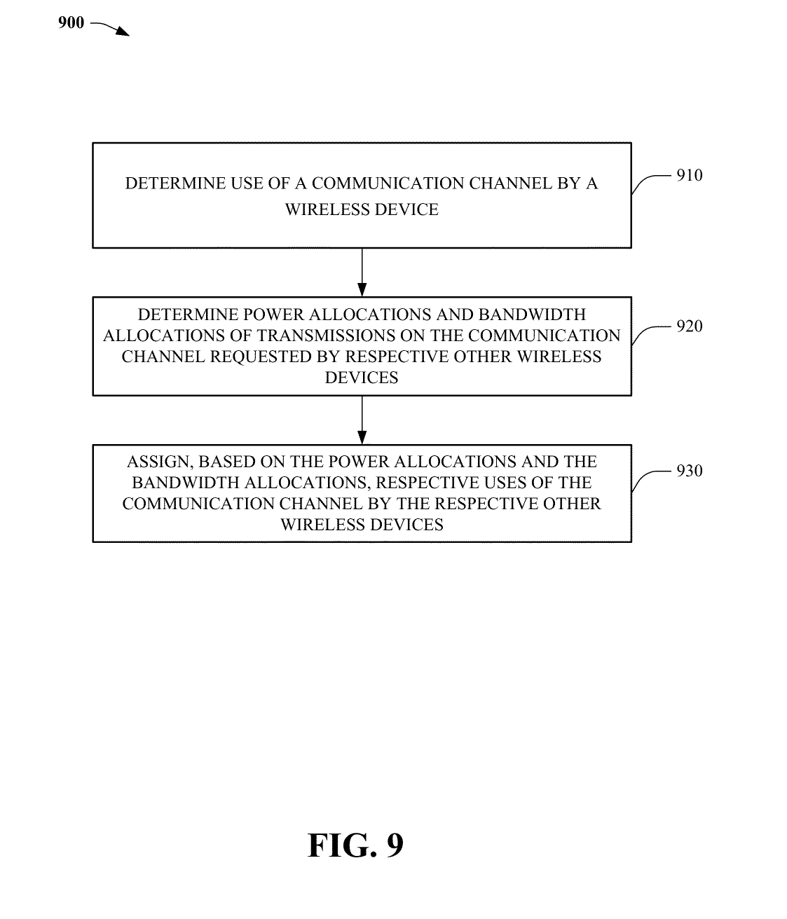

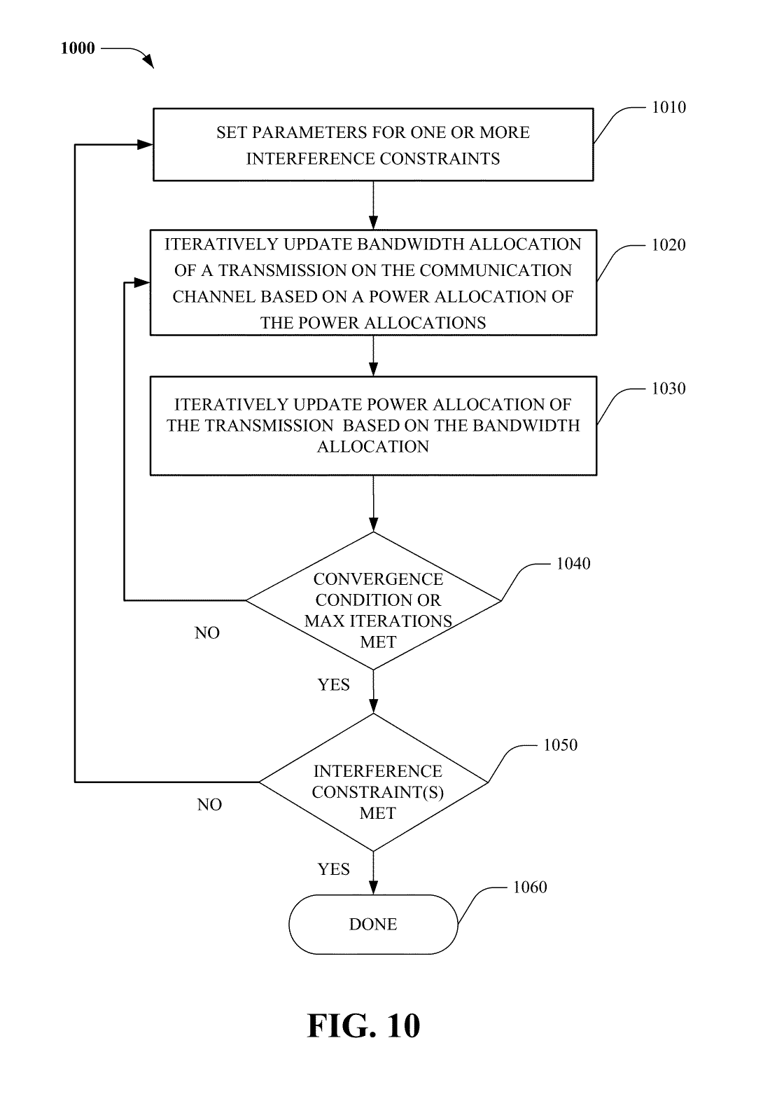

FIGS. 9-10 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 9, a process 900 associated with a CR system, (e.g., 100, 200) is illustrated, in accordance with an embodiment. At 910, a use of a communication channel by a wireless device can be determined. At 920, power allocations of transmissions on the communication channel requested by respective other wireless devices and bandwidth allocations of the transmissions can be determined. At 930, uses of the communication channel by the respective other wireless devices can be assigned, based on the power allocations and the bandwidth allocations.

FIG. 10 illustrates another process (1000) associated with the CR system, in accordance with an embodiment. At 1010, parameters for one or more interference constraints can be set. At 1020 a bandwidth allocation of a transmission on the communication channel can be iteratively updated based on a power allocation of the power allocations determined at 920. At 1030, a power allocation of the transmission can be iteratively updated based on the bandwidth allocation. At 1040, it can be determined whether a convergence condition, or a max number of iterations, is met. If the convergence condition, or the max number iterations was met, process 1000 can continue to 1050, at which it can be determined whether the one or more interference constraints were met; otherwise process 1000 can continue to 1020. If it is determined, at 1050, that the one or more interference constraints were met, process 1000 ends at 1060, else process 1000 continues to 1010.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in storage systems described above, non-volatile memory 1122 (see below), disk storage 1124 (see below), and memory storage 1146 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

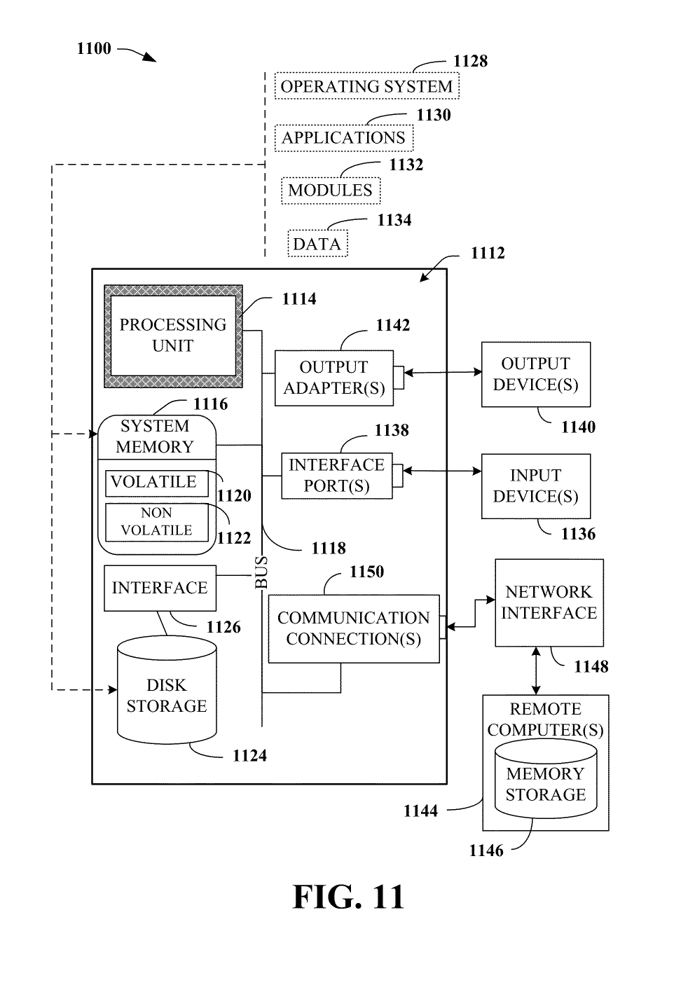

In order to provide a context for the various aspects of the disclosed subject matter, FIG. 11, and the following discussion, are intended to provide a brief, general description of a suitable environment in which the various aspects of the disclosed subject matter can be implemented, e.g., various processes associated with FIGS. 1-10. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 11, a block diagram of a computing system 1100 operable to execute the disclosed systems and methods is illustrated, in accordance with an embodiment. Computer 1112 includes a processing unit 1114, a system memory 1116, and a system bus 1118. System bus 1118 couples system components including, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1116 includes volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can include ROM, PROM, EPROM, EEPROM, or flash memory. Volatile memory 1120 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 can also include removable/non-removable, volatile/non-volatile computer storage media, networked attached storage (NAS), e.g., SAN storage, etc. FIG. 11 illustrates, for example, disk storage 1124. Disk storage 1124 includes, but is not limited to, devices like a magnetic disk drive, floppy disk drive, tape drive, Jaz drive, Zip drive, LS-100 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software includes an operating system 1128. Operating system 1128, which can be stored on disk storage 1124, acts to control and allocate resources of computer 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands or information into computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1114 through system bus 1118 via interface port(s) 1138. Interface port(s) 1138 include, for example, a serial port, a parallel port, a game port, and a universal serial bus (USB). Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140 like monitors, speakers, and printers, among other output devices 1140, which use special adapters. Output adapters 1142 include, by way of illustration and not limitation, video and sound cards that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically includes many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method comprising:
evaluating, by a system comprising a processor, a use of a communication channel by a wireless communication device; and
in response to determining, based on a bandwidth allocation of a transmission on the communication channel requested by another wireless communication device, that a first estimated amount of interference associated with the wireless communication device satisfies a condition with respect to a defined amount of interference, modifying an initial power allocation to obtain a modified power allocation.

2. The method of claim 1, further comprising:
determining a total power allocation of coexisting transmissions on the communication channel associated with wireless communication devices different from the wireless communication device.

3. The method of claim 1, further comprising:
determining bandwidth allocations of transmissions associated with wireless communication devices different from the wireless communication device; and
assigning the use of the communication channel by the wireless communication device based on the bandwidth allocations.

4. The method of claim 3, wherein the determining the bandwidth allocations comprises iteratively updating a selected bandwidth allocation of the bandwidth allocations based on power allocations of the transmissions.

5. The method of claim 3, further comprising iteratively updating a selected power allocation of power allocations of the transmissions based on a selected bandwidth allocation of the bandwidth allocations.

6. The method of claim 1, further comprising:
receiving interference information associated with a communication between a base station device and the other wireless communication device; and
assigning another use of the communication channel based on the interference information.

7. The method of claim 6, wherein the receiving the interference information comprises receiving uplink information associated with uplink interference received by the base station device.

8. The method of claim 7, wherein the assigning the other use of the communication channel based on the interference information comprises:
determining, based on the uplink information, an average level of the uplink interference received by the base station device; and
in response to determining that the average level of the uplink interference satisfies another condition with respect to a defined amount of uplink interference, assigning the other use of the communication channel.

9. The method of claim 8, wherein the determining the average level of the uplink interference includes determining that the average level of the uplink interference satisfies the other condition based on at least one of a detection probability that a sensing result indicates the communication channel satisfies a traffic condition with respect to a predetermined amount of traffic, or a false alarm probability that the sensing result indicates the communication channel does not satisfy the traffic condition.

10. The method of claim 1, further comprising:
in response to determining, based on the modified power allocation and the bandwidth allocation, that a second estimated amount of interference does not satisfy the condition, assigning another use of the communication channel by the other wireless communication device.

11. A system, comprising:
a memory to store instructions; and
a processor, coupled to the memory, that facilitates execution of the instructions to at least:
receive information representing that a communication channel assigned to a wireless device is idle;
receive one or more requests, from respective other wireless devices, to transmit information via the communication channel; and
in response to a determination, based on an allocation of bandwidth for a request of the one or more requests, that a first estimated level of interference associated with the wireless device satisfies a condition with respect to a predetermined level of interference, modify an initial allocation of power to obtain a modified allocation of power.

12. The system of claim 11, wherein the processor further facilitates the execution of the instructions to determine a sum comprising a first value representing the initial allocation of power and a second value representing the modified allocation of power to obtain a result, and grant the request based on the result.

13. The system of claim 11, wherein the processor further facilitates the execution of the instructions to compute bandwidth allocations for a plurality of requests of the one or more requests, and grant the request based on the bandwidth allocations.

14. The system of claim 11, wherein the processor further facilitates the execution of the instructions to iteratively compute another allocation of another bandwidth based on the modified allocation of power.

15. The system of claim 11, wherein the processor further facilitates the execution of the instructions to:
receive power gain information associated with a communication between a base station device and a wireless device of the other wireless devices; and
grant the request based on the power gain information.

16. The system of claim 15, wherein the processor further facilitates the execution of the instructions to receive uplink information corresponding to uplink interference associated with the base station device.

17. The system of claim 16, wherein the processor further facilitates the execution of the instructions to:
determine, based on the uplink information, an average uplink interference associated with the base station device; and
grant the request based on the average uplink interference.

18. The system of claim 17, wherein the processor further facilitates the execution of the instructions to grant the request in response to the average uplink interference being determined to satisfy an interference condition with respect to a predetermined amount of uplink interference.

19. The system of claim 11, wherein the information comprises quality of service information associated with the request.

20. The system of claim 11, wherein the processor further facilitates the execution of the instruction to:
grant the request in response to a determination, based on the modified allocation of power, that a second estimated level of interference associated with the wireless device does not satisfy the condition.

21. An apparatus, comprising:
means for determining a use of a communication channel by a wireless device;
means for determining, based on an allocation of bandwidth for a request for a transmission on the communication channel by another wireless device, an output representing that a first estimated amount of interference associated with the wireless device satisfies a condition with respect to a defined amount of interference; and
means for modifying an initial power allocation based on the output.

22. The apparatus of claim 21, further comprising:
means for determining another allocation of bandwidth based on another output that is associated with the means for modifying the initial power allocation.

23. The apparatus of claim 21, further comprising:
means for determining, based on the output, another output representing that a second estimated amount of interference associated with the wireless device does not satisfy the condition; and
means for granting the request based on the other output.

24. A computer readable storage medium including computer-executable instructions that, in response to execution, cause a computing device to perform operations comprising:
evaluating a utilization of a communication channel by a mobile device; and
iteratively determining, based on a bandwidth allocation for a request for a transmission on the communication channel, a power for the transmission in response to determining that an estimated amount of interference associated with the wireless device satisfies a function of a predetermined amount of interference.

25. The computer readable storage medium of claim 24, wherein the operations further comprise:
reducing a total power allocation of coexisting transmissions on the communication channel.

26. The computer readable storage medium of claim 24, wherein the operations further comprise:
in response to assigning another utilization of the communication channel by the other mobile device, iteratively updating another bandwidth allocation based on a selected power allocation.

27. The computer readable storage medium of claim 24, wherein the operations further comprise:
in response to determining, based on the power, that the estimated amount of interference does not satisfy the condition, assigning another utilization of the communication channel by the other mobile device.
